(19) United States
(12) Patent Application Publication
(10) Pub. No.: US 2017/0218792 A1
(43) Pub. Date: Aug. 3, 2017

(54) ROTOR-STATOR COMBINATION FOR AN AXIAL TURBOMACHINE AND AERO ENGINE

(71) Applicant: MTU Aero Engines AG, Munich (DE)

(72) Inventor: Edgar MERKL, Marzling (DE)

(21) Appl. No.: 15/417,495

(22) Filed: Jan. 27, 2017

(30) Foreign Application Priority Data
Feb. 2, 2016 (DE) 102016201581.8

(51) Int. Cl. F01D 25/24; F04D 29/52; F02C 3/04; F01D 5/02; F01D 9/04; F04D 29/32; F04D 29/54

(52) U.S. Cl. CPC F01D 25/246; F04D 29/321; F04D 29/522; F04D 29/542; F01D 5/02; F01D 9/041; F02C 3/04; F05D 2220/323; F05D 2230/10; F05D 2230/50

(57) ABSTRACT

Disclosed is a rotor-stator combination for an axial turbomachine which comprises a rotor having an impeller and a stator having a diffuser and a casing section. The combination features a one-piece structural design in manufacture and the casing section has at least one radial access which is prepared and designed for installation steps and/or machining steps for rotor sections and/or stator sections which are arranged inside the casing section. Also disclosed is an aero engine comprising such a rotor-stator combination.

### CROSS-REFERENCE TO RELATED APPLICATIONS

The present application claims priority under 35 U.S.C. §119 of German Patent Application No. 102016201581.8, filed Feb. 2, 2016, the entire disclosure of which is expressly incorporated by reference herein.

### BACKGROUND OF THE INVENTION

1. Field of the Invention

The present invention relates to a rotor-stator combination for an axial turbomachine and to an aero engine comprising the rotor-stator combination.

2. Discussion of Background Information

The manufacture and installation of rotors into a casing of turbomachines is very complex, costly and time-intensive. The rotors have to be designed and produced to fit precisely, wherein the installation process also has to be integrated into all the individual steps during the construction and manufacture of the rotors. The impellers of rotors can be manufactured in an integral structural design or by means of individual impeller blades which are connected to a rotor basic body, wherein both variants have advantages and disadvantages. The diffusers as a rule are produced and installed by means of individual diffuser blades which are connected to the casing. All the individual components, moreover, should be optimized, especially cost optimized, with regard to constructional details, weight, and production and installation. The entire combination of the individually produced rotors and stators can be referred to as a rotor-stator combination.

It would be advantageous to have available a further rotor-stator combination for an axial turbomachine which is optimized taking into account the mentioned problems. It would also be advantageous to have available an aero engine comprising a corresponding rotor-stator combination.

### SUMMARY OF THE INVENTION

The present invention provides a rotor-stator combination for an axial turbomachine. The combination comprises at least one rotor comprising an impeller and at least one stator comprising a diffuser and a casing section. The rotor-stator combination further features a one-piece structural design in manufacture and the casing section has at least one radial access which is prepared and designed for installation steps and/or machining steps for rotor sections and/or stator sections that are arranged inside the casing section.

In one aspect of the combination, the rotor-stator combination may be a compressor and/or a turbine, or may comprise such.

In another aspect of the combination, the rotor-stator combination may further comprise a combustion chamber.

In yet another aspect of the combination, the radial access may comprise a sealing device.

In a still further aspect, the rotor-stator combination may be manufactured from one material or the the rotor-stator combination may be manufactured from at least two different materials, or may feature such. For example, the impeller blades may be manufactured from a first material, or feature such, and at least one casing section may be manufactured from a second material, or feature such, the first material and the second material being different. Further, the impeller blades together with a rotor basic body may be manufactured from the first material and/or the diffuser blades may be manufactured from the second material or from a third material, or may feature such.

In another aspect, the rotor-stator combination may comprise a support structure and/or a retaining device during manufacture.

In another aspect, the rotor-stator combination may comprise at least one connecting flange for connecting the rotor-stator combination to one or more additional components of the turbomachine.

The present invention also provides an aero engine which comprises the rotor-stator combination set forth above (including the various aspects thereof). For example, the rotor-stator combination may comprise a high-pressure compressor and/or may comprise a high-pressure turbine.

As set forth above, the invention provides a rotor-stator combination for an axial turbomachine which on the one hand comprises at least one rotor with an impeller and on the other hand at least one stator with a diffuser and a casing section. The rotor-stator combination features a one-piece structural design in manufacture. The casing section has at least one radial access. The radial access is prepared and designed for installation steps and/or machining steps for rotor sections and/or stator sections which are arranged inside the casing section.

An aero engine according to the invention comprises a rotor-stator combination as set forth above, where the rotor-stator combination comprises a high-pressure compressor and/or a high-pressure turbine.

Exemplary embodiments according to the invention can have one or more of the features which are mentioned below.

In specific embodiments according to the invention, the axial turbomachine is an axial gas turbine, for example an aero gas turbine. An axial turbomachine can be referred to as an aero engine. An aero engine can comprise a compressor having a plurality of compressor stages and a turbine having a plurality of turbine stages. Compressor stages and turbine stages can in each case have a plurality of rotor stages and a plurality of stator stages.

The term “rotor”, as it is used herein, can comprise one or more rotor stages which in the intended use of the turbomachine rotate around an axis of rotation or rotational axis of the turbomachine. A rotor or a rotor stage can be referred to as an impeller or can comprise an impeller. A rotor or a rotor stage can comprise a plurality of impellers. A rotor or a rotor stage can comprise a plurality of impeller blades and a rotor basic body. The rotor basic body can be referred to as a rotor disk or rotor ring or can comprise this.

A rotor can be incorporated and installed into a turbomachine, especially into an axial gas turbine.

A materially locking connection (a materially locking connection can be referred to as a materially bonding connection), for example of the impeller blades of a rotor or of an impeller to a rotor basic body, can be referred to as an integral connection. An integral connection can be produced by means of a generative manufacturing process. A rotor basic body with blades which are integrally connected to the rotor basic body can be referred to as an integrally bladed rotor. An integrally bladed rotor can be a so-called BUSK (bladed disk) or a BUNG (blade ring).

The term “one-piece”, as it is used herein, can refer to a material feature of an integral component. In particular, a one-piece component is produced or manufactured by means of a single manufacturing step or manufacturing process. A one-piece component can be produced by means of a generative manufacturing process. A generative manufacturing process is for example selective laser sintering (SLS, for short). A generative manufacturing process can be referred to as additive manufacturing (AM, for short). A generative manufacturing process can also be referred to as direct metal laser sintering (DMLS, for short), selective laser melting (SLM, for short), or as 3D printing or feature such a process. Generative manufacturing processes (the term manufacturing process is synonymous to production process here) can be used for so-called “rapid prototyping”.

A one-piece structural design in manufacture can mean that a component or assembly is one-piece in manufacture. A one-piece structural design can feature a plurality of individual components in a component which is produced in one piece. Therefore, for example a rotor, which in later intended use rotates around an axis, together with a stator, which can comprise diffusers and/or a casing and is static in later intended use, therefore non-movable, can be produced together in manufacture in a one-piece structural design and in one manufacturing step. The separation of the components after one-piece manufacture can be achieved for example by means of support structures, parting joints, predetermined break points or other provisions.

The rotor can be designed or prepared for direct or indirect connecting to a shaft of the turbomachine.

The term “stator”, as it is used herein, can mean a casing of a turbomachine or individual casing sections. The stator can also comprise components which are connected to the casing. In particular, a diffuser or individual diffuser elements, such as diffuser blades, can be part of the stator. Furthermore, an inner ring, which interconnects the diffuser blades radially on the inside and radially terminates, can be added to the stator. On the inner ring provision can also be made for inlet seals or at least retainers or devices for the fastening of inlet seals. Inner linings of the casing, casing sections, intermediate casings or the like can also be added to the stator.

A rotor section can comprise an impeller, an impeller blade or, for example, the radially outer end of one or more impeller blades. A rotor section can also be any other region or section of the rotor.

A stator section can comprise a diffuser, a diffuser blade or, for example, the radially outer mounting or fastening of the diffuser blades on the casing. A diffuser section can also be any other region or section of the stator.

The term “connecting flange”, as it is used herein, can mean a component for the especially positive locking and/or non-positive locking type of connecting or flanging of a rotor-stator combination on, or to, an adjoining component of the turbomachine. A connecting flange can be referred to as a fastening element.

In some embodiments according to the invention, the rotor-stator combination is a compressor and/or a turbine or comprises such. A compressor can, for example, be a high-pressure compressor or a low-pressure compressor. A turbine can, for example, be a high-pressure turbine or a low-pressure turbine.

In specific embodiments according to the invention, the rotor-stator combination comprises a combustion chamber. A combustion chamber is especially arranged between the high-pressure compressor and the high-pressure turbine of a turbomachine, especially of an axial gas turbine.

In some embodiments according to the invention, the radial access has a sealing device. The sealing device can be a cover which, for example, can be closed by means of a suitable locking mechanism such as a hook or screws. The radial access especially enables access, for example manual access, for maintenance and repair operations and also installation operations inside the rotor-stator combination.

In certain embodiments according to the invention, the rotor-stator combination is manufactured from one material. For example, when a generative manufacturing process is being used to produce the rotor-stator combination it can be advantageous to use only one material, for example in a laser sintering process with metal. The material can be selected according to various criteria, for example in order to ensure adequate dimensional stability and strength of the individual components of the rotor-stator combination.

In some embodiments according to the invention, the rotor-stator combination is manufactured from at least two different materials, or features two different materials. The different materials can, for example, be applied by different material layers during a generative manufacturing process. Alternatively, different materials in powder form or globular form can be used for the generative manufacturing process, for example for a laser sintering process. By means of different materials, material properties can advantageously be combined, which would not be possible in, for example, a casting process or a cutting manufacturing process of the rotor-stator combination.

In specific embodiments according to the invention, the impeller blades are manufactured from a first material, or feature a first material. The casing section in this exemplary embodiment is manufactured from at least a second material, or features a second material, wherein the first material and the second material are different.

In some embodiments according to the invention, the impeller blades together with a rotor basic body are manufactured from the first material. This constructional design can be referred to as a one-piece form of impeller blades and rotor basic body.

This one-piece form can be referred to as a so-called BLISK (bladed disk) or as a BLING (blade ring). The one-piece form of impeller blades and rotor basic body can be referred to as an integrally bladed rotor.

In certain embodiments according to the invention, the diffuser blades are manufactured from the second material or from a third material, or feature a second material or third material.

In some embodiments according to the invention, the rotor-stator combination has a support structure and/or a retaining device during manufacture. A support structure can be constructed in a first manufacturing step by means of a generative process in order to then construct the actual rotor-stator combination on this support structure. The support structure can be removed again after the production of the rotor-stator combination. By means of the support structure, constructing the rotor-stator combination directly on a baseplate can advantageously be dispensed with. The support structure can stabilize the rotor-stator combination during the layered construction and possibly contribute to the maintaining of manufacturing accuracies.

The support structure can connect rotor components and stator components during the one-piece manufacture and are detached after manufacture. In this way, a plurality of components can advantageously be manufactured in one production step.

The retaining device can advantageously be used in order to fix and retain the rotor-stator combination, especially after manufacture using a support structure, in order to remove said support structure.

In specific embodiments according to the invention, the rotor-stator combination has at least one connecting flange for connecting the rotor-stator combination to one or more additional components of the turbomachine. Additional components can, for example, be compressor segments, turbine segments, combustion chamber segments or adjoining casing segments in order to fix and install the rotor-stator combination in the turbomachine. Connecting flanges can be connected to adjoining flanges by means of screwed connections.

Some of the embodiments, or all of the embodiments, according to the invention can feature one, a multiplicity, or all the advantages which are mentioned above and in the following text.

By means of the rotor-stator combination according to the invention, the rotor can be manufactured together with the stator in one production step. As a result, additional flanges or slots, which as a rule are required in the case of a separate-part production for installation, can advantageously be dispensed with.

Furthermore, by means of the rotor-stator combination according to the invention, constructionally complicated components with undercuts and special profilings can be manufactured in one production step. The rotor-stator combination according to the invention enables the most diverse design possibilities for the construction.

By means of the rotor-stator combination according to the invention, different materials can advantageously be used during construction and manufacture. As a result, new or additional boundary conditions with regard to the structure mechanics or the strength of rotors and stators can advantageously be achieved in the combination.

Furthermore, by means of the rotor-stator combination further design optimization possibilities, which can advantageously lead to savings in weight, to manufacturing cost reductions and to design optimizations, can be achieved and introduced.

### BRIEF DESCRIPTION OF THE DRAWING

The present invention is explained by way of example in the following text with reference to the attached drawing in which identical designations refer to the same or similar components. In the schematically simplified drawing:

FIG. 1 shows a rotor-stator combination according to an embodiment of the invention.

### DETAILED DESCRIPTION OF EMBODIMENTS OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description in combination with the drawing making apparent to those of skill in the art how the several forms of the present invention may be embodied in practice.

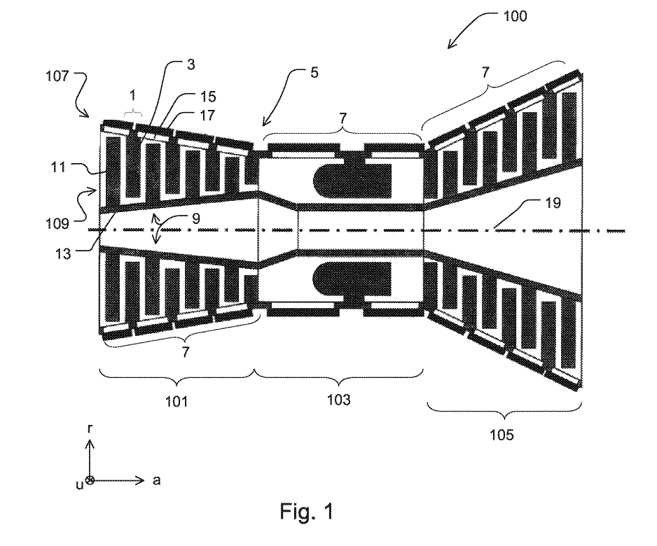

FIG. 1 shows in a longitudinal sectional view a rotor-stator combination 100 according to the invention of an axial turbomachine having a compressor 101, a combustion chamber 103 and a turbine 105.

The rotor-stator combination 100 comprises a stator 107 and a rotor 109. The stator 107 has a plurality of diffusers 1, which are arranged in series in the axial direction a, having in each case a plurality of diffuser blades 3 which are arranged in a distributed manner over the circumference u, and a casing 5 having individual casing sections 7. The rotor 109 has a plurality of impellers 9, which are arranged in series in the axial direction a, having in each case a plurality of impeller blades 11, which are arranged in a distributed manner over the circumference u, and at least one rotor basic body 13.

The casing 5, in a plurality of casing sections 7, has numerous radial accesses 15 which are arranged in series in the axial direction a and are designed as radial openings. The radial openings can have different circumferential angles or opening angles over the circumference u. For example, four or more openings with, for example, a circumferential angle of 20 degrees, 30 degrees or another angle can be arranged in each case. The radial accesses 15 can be referred to as openings for the casing interior. The radial accesses 15 are closed off by means of sealing devices 17 which are designed as covers. The sealing devices 17 or covers can additionally have hooks for the closure and/or seals for airtight sealing (not shown in FIG. 1).

The rotor-stator combination 100 also has a longitudinal axis 19.

### List of reference numerals

a Axial; axial direction

r Radial; radial direction

u Circumferential direction

100 Rotor-stator combination

101 Compressor

103 Combustion chamber

105 Turbine

107 Stator

109 Rotor

1 Diffuser

3 Diffuser blade

5 Casing

7 Casing section

9 Impeller

11 Impeller blade

13 Rotor basic body

15 Radial access

17 Sealing device

19 Longitudinal

What is claimed is:

1. A rotor-stator combination for an axial turbomachine, wherein the combination comprises at least one rotor comprising an impeller and at least one stator comprising a diffuser and a casing section, the rotor-stator combination featuring a one-piece structural design in manufacture and the casing section having at least one radial access which is prepared and designed for installation steps and/or machining steps for rotor sections and/or stator sections arranged inside the casing section.

2. The rotor-stator combination of claim 1, wherein the rotor-stator combination is a compressor, or comprises such.

3. The rotor-stator combination of claim 1, wherein the rotor-stator combination is a turbine, or comprises such.

4. The rotor-stator combination of claim 1, wherein the rotor-stator combination further comprises a combustion chamber.

5. The rotor-stator combination of claim 1, wherein the radial access comprises a sealing device.

6. The rotor-stator combination of claim 1, wherein the rotor-stator combination is manufactured from one material.

7. The rotor-stator combination of claim 1, wherein the rotor-stator combination is manufactured from at least two different materials, or features such.

8. The rotor-stator combination of claim 1, wherein impeller blades are manufactured from a first material, or feature such, and at least one casing section is manufactured from a second material, or features such, the first material and the second material being different.

9. The rotor-stator combination of claim 8, wherein impeller blades together with a rotor basic body are manufactured from the first material.

10. The rotor-stator combination of claim 8, wherein diffuser blades are manufactured from the second material or from a third material, or feature such.

11. The rotor-stator combination of claim 9, wherein diffuser blades are manufactured from the second material or from a third material, or feature such.

12. The rotor-stator combination of claim 1, wherein the rotor-stator combination comprises a support structure and/or a retaining device during manufacture.

13. The rotor-stator combination of claim 1, wherein the rotor-stator combination comprises at least one connecting flange for connecting the rotor-stator combination to one or more additional components of the turbomachine.

14. An aero engine, wherein the aero engine comprises the rotor-stator combination of claim 1.

15. The aero engine of claim 14, wherein the rotor-stator combination comprises a high-pressure compressor.

16. The aero engine of claim 14, wherein the rotor-stator combination comprises a high-pressure turbine.

17. A method of manufacturing a rotor-stator combination for an axial turbomachine, wherein the combination comprises at least one rotor comprising an impeller and at least one stator comprising a diffuser and a casing section, and the rotor is manufactured together with the stator in one production step, the rotor-stator combination features a one-piece structural design, and the casing section has at least one radial access which is prepared and designed for installation steps and/or machining steps for rotor sections and/or stator sections arranged inside the casing section.
